(19) United States
(12) Patent Application Publication
(10) Pub. No.: US 2019/0321850 A1
(43) Pub. Date: Oct. 24, 2019

(54) MULTI-LAYER COATING SYSTEM, METHOD OF APPLYING THE SAME AND SUBSTRATE COATED THEREWITH

(71) Applicant: PPG Coatings (Tianjin) Co., Ltd., Tianjin (CN)

(72) Inventors: Yuanjie Song, Nantong (CN); Zhengsong Luo, Suzhou (CN); Haifeng Liu, Suzhou (CN)

(73) Assignee: PPG Coatings (Tianjin) Co., Ltd., Tianjin (CN)

(21) Appl. No.: 16/474,730

(22) PCT Filed: Dec. 27, 2017
(86) PCT No.: PCT/CN2017/119028

§ 371 Date: Jun. 28, 2019

(30) Foreign Application Priority Data
Dec. 30, 2016 (CN) 201611255059.0

(51) Int. Cl. B05D 3/06; B05D 7/00; C08F 290/06; C09D 175/04; B05D 3/02

(52) U.S. Cl. CPC B05D 3/067; B05D 7/536; C08F 290/067; C08L 2205/025; B05D 3/0254; B05D 2201/02; B05D 2503/00; C09D 175/04

(57) ABSTRACT

A multi-layer coating system comprises a first and a second ultraviolet curable coating composition. The first ultraviolet curable coating composition comprises a low hydroxyl value polyurethane resin and a urethane acrylate oligomer. The second ultraviolet curable coating composition comprises a urethane acrylate oligomer and an active monomer. A method of coating a substrate with the multi-layer coating system and the substrate coated with the multi-layer coating system are also provided.

### FIELD OF INVENTION

The present invention relates to a UV curable multi-layer coating system, and in particular to a multi-layer coating system comprising a first UV curable coating composition which comprises a low hydroxyl polyurethane resin and a polyurethane acrylate oligomer and a second UV curable coating composition having a soft-touch feel which comprises a polyurethane acrylate oligomer and an active monomer. The present invention also relates to a method of coating a substrate with the multi-layer coating system and the substrate coated with the multi-layer coating system.

### BACKGROUND OF THE INVENTION

At present, electronic products especially laptops have a shell usually coated with a system comprising a polyurethane (PU) basecoat and a polyurethane leather (soft touch feeling) topcoat. Both PU basecoat and topcoat require a curing agent. Disadvantages of the system include short lifetime, long baking time, too much energy consumption, and low production efficiency. A UV curable system by combining a UV curable basecoat and a UV curable leather topcoat has been developed. In such UV curable system, the basecoat paint film will be completely formed upon UV curing without a baking procedure, thereby saving energy and extending lifetime of the coating. The UV leather topcoat has advantages of fast curing, energy-saving, high production efficiency, and good curing performance. It further exhibits a soft touch feeling like PU leather, and thus is suitable for high-speed automatic production.

However, current UV basecoat plus leather topcoat system shows problems like instable adhesion, strong odour, poor scratch resistance and poor gloss stability. Therefore, there is a need for a UV curable multi-layer coating system having improved performance in the art.

### SUMMARY OF THE INVENTION

The present invention provides a multi-layer coating system, comprising a first UV curable coating composition and a second UV curable coating composition, wherein the first UV curable coating composition comprises a low hydroxyl polyurethane resin and a polyurethane acrylate oligomer, and the second UV curable coating composition comprises a polyurethane acrylate oligomer and an active monomer. The present invention also provides a method of coating a substrate with the multi-layer coating system and the substrate coated with the multi-layer coating system.

The present invention also provides a method of forming a multi-layer coating system on a substrate, comprising: (1) applying a first UV curable coating composition to at least a portion of the substrate, to form a base coat; and (2) applying a second UV curable coating composition to at least a portion of the base coat, to form a clear coat, wherein the first UV curable composition comprises a low hydroxyl polyurethane resin and a polyurethane acrylate oligomer, and the second UV curable composition comprises a polyurethane acrylate oligomer and an active monomer.

The present invention also provides a coated substrate, comprising:

(i) a substrate, and (ii) a multi-layer coating system deposited on at least a portion of the substrate, Wherein the multi-layer coating system comprises a first UV curable coating composition and a second UV curable coating composition, wherein the first UV curable coating composition comprises a low hydroxyl polyurethane resin and a polyurethane acrylate oligomer, and the second UV curable coating composition comprises a polyurethane acrylate oligomer and an active monomer.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims, are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in the description and appended claim, the articles “a”, “an”, and “the” include plural references, unless specifically stated as one reference.

As used herein, the weight average molecular weight (Mw) of a polymer is determined by gel permeation chromatography using an appropriate standard such as a polystyrene standard.

As used herein, the term “hydroxyl value” is the mass of potassium hydroxide (KOH) in milligrams that is equivalent to hydroxyl groups in one gram of sample, expressed in an unit of mg KOH/g.

According to the present invention, a multi-layer coating system is provided, which comprises a first UV curable coating composition and a second UV curable coating composition, wherein the first UV curable coating composition comprises a low hydroxyl polyurethane resin and a polyurethane acrylate oligomer, and the second UV curable coating composition comprises a polyurethane acrylate oligomer and an active monomer.

The first UV curable coating composition is coated on at least a portion of a substrate as a base coat.

In the first UV curable coating composition, the low hydroxyl polyurethane resin has a hydroxyl value from 20 to 30 KOH/g and a weight average molecular weight from 5000 to 20000. Such low hydroxyl polyurethane resin can enhance adhesion of the basecoat to the topcoat and improve coatability, such as leveling property, color-spreading property, and sandability.

Typically, the low hydroxyl polyurethane resin is present in the first coating composition in an amount of 20-70% by weight of the first coating composition. When the amount of the low hydroxyl polyurethane resin is less than 20 wt %, the coating film formed from the first coating composition exhibits poor adherence. When the amount thereof is higher than 70 wt %, the coating film formed from the first coating composition shows poor adherence and anti-biting.

Many of such low hydroxyl polyurethane resins which are commercially available can be used in the present invention. For example, examples of such low hydroxyl polyurethane resins that can be used in the present invention include, but are not limited to, ACRYDIC SHA-288 from DIC, A-1209 from Jiahe, and any combination thereof.

The first coating composition further comprises a polyurethane acrylate oligomer. Said polyurethane acrylate oligomer comprises a UV curable polyurethane acrylate oligomer having two or three functionality. Preferably, the polyurethane acrylate oligomer comprises a two-functionality polyurethane acrylate oligomer. The polyurethane acrylate oligomer preferably has a weight average molecular weight from 20000 to 50000 with a solid content of 60-70%. Said polyurethane acrylate oligomer exhibits superior adhesion to metals including aluminum and stainless steel on plastic substrates and has excellent chemical and water-boiling resistance.

The polyurethane acrylate oligomer is present in the first coating composition in an amount of about 5-30% by weight of the first coating composition. When the amount of the polyurethane acrylate oligomer is less than 5 wt %, the coating film formed from the first coating composition exhibits poor adherence and is prone to biting. When the amount thereof is higher than 30 wt %, the coating film formed from the first coating composition shows poor adherence to the substrate.

Many of such polyurethane acrylate oligomers which are commercially available can be used in the present invention. For example, examples of such polyurethane acrylate oligomers that can be used in the present invention include, but are not limited to, RA3090 from Mitsui; 6071, 6075-1, and 6075-3 from Changxing, and any combination thereof.

The first UV curable coating composition of the multi-layer coating system according to the present invention further comprises a photoinitiator. There is no particular limitation to the photoinitiator used, as long as it can decompose to generate free radicals upon exposure to light radiation and initiate a photopolymerization reaction. Available photoinitiators include, but are not limited to benzoin derivative, benzil ketal derivateice, dialkoxy acetophenone, α-hydroxyalkylphenylketone, α-aminealkylphenylketone, acyl phosphine hydride, esterified oxime ketone compounds, aryl peroxide ester compounds, halo methyl aryl ketone, organic sulphur-containing compounds, benzoylformate, and the like. Two or more photoinitiators may be selected as needed. The photoinitiator can comprise 0.05-5% and preferably 0.1-3% by weight of the UV curable coating composition.

Many commercially available photoinitiators can be used in the present invention. For example, examples of such photoinitiators that can be used in the present invention include, but are not limited to, 184/BP/MBF/TPO from DBC, 184/BP/MBF/819/TPO from Ciba, and any combination thereof.

The first coating composition of the multi-layer coating system according to the present invention may further comprises an organic solvent and one or more other additives commonly used in the field to which the present invention belongs.

There is no specific limitation to the solvent used, which can be any of organic solvents known by those skilled in the art and which includes, without limitation, an aliphatic or aromatic hydrocarbon such as Solvesso 100™, toluene or xylene, an alcohol such as butanol or isopropanol, an ester such as ethyl acetate, butyl acetate or iso-butyl acetate, a ketone such as acetone, methyl isobutyl ketone or methyl ethyl ketone, an ether, an ether-alcohol or an ether ester such as ethyl 3-ethoxypropionate, or a mixture of any of the aforesaid. Preferably it is ethyl acetate and/or methyl ethyl ketone. The solvent is usually in an amount of 0-50 wt % of the first coating composition.

Said one or more other additives include, but are not limited to an adhesion-promoting agent, an anti-settling agent, a dispersant, a leveling agent, an antioxidant, a deforming agent, a rheological agent, and the like. The types of these additives are well-known by those skilled in the art and the amount thereof will be easily determined by those skilled in the art as needed.

The first coating composition may further comprise a cellulose ester additive, such as cellulose acetate (CA), cellulose acetate propionate (CAP), and/or cellulose acetate butyrate (CAB). Such additives can improve the appearance of the base-plus-clear coating system by improving the flow and leveling of the first coating composition and improving metal flake orientation if such flakes are present in the first coating composition to provide a “metallic” look. Moreover, such additives can contribute to reducing intermixing of the subsequently applied second coating composition (UV curable composition) by promoting fast drying and early hardness development of the first coating composition. Typically, the cellulose ester can be present in any amount sufficient to impart the desired coating properties. For example, such cellulose ester may comprise from 0 to 20 wt % of the first coating composition.

The second UV curable coating composition is coated onto at least a portion of the first coating composition as a clear coat.

The second UV curable coating composition according to the present invention comprises a polyurethane acrylate oligomer having a weight average molecular weight from 1000 to 20000 and an active monomer.

Preferably, the polyurethane acrylate oligomer comprises a low-functionality polyurethane acrylate oligomer (a) and a high-functionality polyurethane acrylate oligomer (b).

The polyurethane acrylate oligomer (a) is preferably a two (2)-functionality polyurethane acrylate oligomer. Said oligomer exhibits good flexibility and soft-touch feeling, with low reaction speed and crosslink density. The polyurethane acrylate oligomer (b) is preferably an aliphatic polyurethane acrylate oligomer having functionality from 6 to 9. Said oligomer has excellent UV curing property, good RCA abrasion resistance and low surface energy property. The low-functionality polyurethane acrylate oligomer (a) and the high-functionality polyurethane acrylate oligomer (b) are used in combination to impart the topcoat layer desirable soft-touch feeling, high hardness, and high abrasion resistance.

Preferably, the second coating composition comprises about 10-50 wt % of low-functionality polyurethane acrylate oligomer (a) and about 1-15 wt % of high-functionality polyurethane acrylate oligomer (b), based on the weight of the second coating composition.

Many commercially available polyurethane acrylate oligomers can be used in the present invention. For example, examples of such low-functionality polyurethane acrylate oligomers (a) that can be used in the present invention include, but are not limited to, A&H-14K from Gifu and the like. Examples of such low-functionality polyurethane acrylate oligomers (a) that can be used in the present invention include, but are not limited to, CWD-72 from Negami, UA-893 from Jesida of Zhongshan and the like.

The second coating composition further comprises an active monomer. The active monomer is preferably a low-function one, particularly two-function active monomer. Such low-function active monomer can increase adhesion and crosslinking density of the coat. Moreover, such low-function active monomer will not impair the soft-touch feeling of the coat, while multiple-function (functionality greater than or equal to 3) will lead to a hard feeling.

The active monomers that can be used in the present invention include, but are not limited to, dipropyleneglycol diacrylate, tripropylene glycol diacrylate ester, 1,6-hexanediol diacrylate, diethylene glycol dimethacrylate, polyethylene glycol (400) diacrylate, polyethylene glycol diacrylate (600), diethylene glycol dimethacrylate, ethoxylated bisphenol dimethacrylate, tricyclodecane dimethylol diacrylate, propoxide (2) neopentyl glycol diacrylate, and any combination thereof.

The active monomer may be present in an amount of 5-25% by weight of the second UV curable coating composition.

Many commercially available active monomers can be used in the present invention. For example, examples of such photoinitiators that can be used in the present invention include, but are not limited to, TMPTA, TPGDA, and DPHA from Changxing, SR399 from Sartomer, and any combination thereof.

The second UV curable coating composition according to the present invention further comprises a photoinitiator. There is no particular limitation to the photoinitiator used, as long as it can decompose to generate free radicals upon exposure to light radiation and initiate a photopolymerization reaction. Available photoinitiators include, but are not limited to benzoin derivative, benzil ketal derivateice, dialkoxy acetophenone, α-hydroxyalkylphenylketone, α-aminealkylphenylketone, acyl phosphine hydride, esterified oxime ketone compounds, aryl peroxide ester compounds, halo methyl aryl ketone, organic sulphur-containing compounds, benzoylformate, and the like. Two or more photoinitiators may be selected as needed. The photoinitiator can comprise 0.05-10% by weight of the UV curable coating composition.

Many commercially available photoinitiators can be used in the present invention. For example, examples of such photoinitiators that can be used in the present invention include, but are not limited to, 184/BP/MBF from DBC, 184/BP/MBF/819 from Ciba, KIP160 from IGM, and any combination thereof.

The second coating composition of the multi-layer coating system according to the present invention may further comprises an organic solvent and one or more other additives commonly used in the field to which the present invention belongs, in addition to the aforesaid components.

There is no specific limitation to the solvent used, which can be any of organic solvents known by those skilled in the art and which includes, without limitation, an aliphatic or aromatic hydrocarbon such as Solvesso 100™, toluene or xylene, an alcohol such as butanol or isopropanol, an ester such as ethyl acetate, butyl acetate or iso-butyl acetate, a ketone such as acetone, methyl isobutyl ketone or methyl ethyl ketone, an ether, an ether-alcohol or an ether ester such as ethyl 3-ethoxypropionate, or a mixture of any of the aforesaid. Preferably it is ethyl acetate and/or methyl ethyl ketone. The solvent is usually in an amount of 0-50 wt % of the first coating composition.

Said one or more other additives include, but are not limited to a dispersant, a leveling agent, a mating agent, an antioxidant, a deforming agent, a rheological agent, and the like. The types of these additives are well-known by those skilled in the art and the amount thereof will be easily determined by those skilled in the art as needed.

In one embodiment, the present invention further provides a method of forming the multi-layer coating system on a substrate, comprising applying the first coating composition to at least a portion of the substrate as a base coat, and applying the second coating composition to at least a portion of the first coating composition as a clear coat.

Typically, the first coating composition is applied onto at least a portion of the substrate by known techniques in the art. For example, the first coating composition may be applied onto at least a portion of the substrate by spraying. The first coating composition may be cured by any of appropriate methods known in the art. Preferably, curing may be achieved by baking at 60-80° C. for 10-30 min to evaporate the solvent, followed by UV irradiating at UV energy of 400-1000 mJ/cm² and light intensity of 80-250 mW/cm². The film thickness of the base coat is usually in the range of 5 to 10 μm.

Thereafter, the second coating composition can be applied on the base coat by any method described above and cured. Preferably, curing can be achieved by baking at 45-60° C. for about 5-10 min to evaporate the solvent, followed by UV irradiating at UV energy of 400-1600 mJ/cm² and light intensity of 80-250 mW/cm². The film thickness of the topcoat is usually in the range of 45 to 55 μm.

The multi-layer coating system of the present invention may be applied to any substrate. Said substrate may include, but are not limited to ceramics, woods, leathers, stones, glass, alloy, paper, plastics, fiber, cotton textiles, and the like, preferably metallic or plastic substrates. The plastic substrates particularly refers to one for an electronic device, such as a mobile phone, personal digital assistant, smart phone, personal computer. For example, the plastic substrate can be formed from the group consisting of polypropylene (PC), acrylonitrile-butadiene-styrene (ABS), glass fiber (GF), and any combination thereof.

### EXAMPLES

The following examples are provided to illustrate the invention, which, however, are not to be considered as limiting the invention to their details. Unless otherwise indicated, all parts and percentages in the following examples, as well as throughout the specification, are by weight.

### Preparation of the First Coating Composition

The first coating composition of the inventive multi-layer coating system was prepared by mixing the components and amounts thereof listed in Table 1.

TABLE 1
Formulation of the first coating composition

| | Example 1 | Example 2 | Example 3 |
|---|---|---|---|
| | (wt %*) | (wt %) | (wt %) |
| Low hydroxyl | 66 | 56 | 41 |
| polyurethane resin ¹ | | | |
| Polyurethane acrylate | 5 | 15 | 30 |
| oligomer ² | | | |
| Photoinitiator³ | 0.55 | 0.55 | 0.55 |
| Solvent⁴ | 21.45 | 21.45 | 21.45 |
| Adhesion-promoting | 2.3 | 2.3 | 2.3 |
| agent⁵ | | | |
| Anti-settling agent⁶ | 0.7 | 0.7 | 0.7 |
| CAB⁷ | 4 | 4 | 4 |
| Total | 100 | 100 | 100 |

*based on total weight of the first coating composition (g);
¹ Trade name 7534, available from Shanghai Shengbao
² Trade name RA3081, available from Mitsui
³Trade name TPO, available from Ciba
⁴Ethyl acetate/methyl ethyl ketone
⁵Trade name APW, available from ELEMENTIS SPECIALTIES
⁶Trade name TROYTHIX 150 ACS, available from TROY CORPORATION
⁷Trade name CAB381-2, available from Eastman

### Preparation of the Second Coating Composition

The second coating composition of the inventive multi-layer coating system was prepared using the components and amounts thereof listed in Table 2.

TABLE 2
Formulation of the second coating composition

| | Example 4 | Example 5 | Example 6 |
|---|---|---|---|
| | (wt %*) | (wt %) | (wt %) |
| Polyurethane | 11.3 | 28.9 | 42.1 |
| acrylate ¹ | | | |
| Polyurethane | 16.9 | 9.6 | 4.2 |
| acrylate ² | | | |
| Active monomer³ | 6.2 | 5.3 | 4.6 |
| Photoinitiator⁴ | 1.5 | 1.3 | 1.1 |
| Solvent⁵ | 56.3 | 48.2 | 42.1 |
| Leveling agent⁶ | 0.3 | 0.3 | 0.3 |
| Dispersant⁷ | 1.4 | 1.2 | 1.0 |
| Matting agent⁸ | 6.1 | 5.2 | 4.6 |
| Total | 100 | 100 | 100 |

*based on total weight of the second coating composition (g);
¹ Trade name CWD-48N, available from Negami
² Trade name UA-893, available from Jesida of Zhongshan
³Trade name HDDA, available from Changxing
⁴Trade name KIP160, available from IGM
⁵Ethyl acetate/methyl ethyl ketone
⁶Trade name BYK-UV3505, available from BYK
⁷Trade name BYK-P104S, available from BYK
⁸Trade name TS100, available from EVONIK DEGUSSA

### Preparation Process of Coats

The first coating compositions shown in Table 1 (Examples 1-3, base coat) were diluted with a diluent formulated by mixing ethyl acetate, isopropanol, and ethylene glycol monobutyl ether in an appropriate ratio, followed by addition of a curing agent, such that the coating compositions after dilution have a viscosity of 8-10 s. Then, the diluted coating compositions were coated onto the substrates (PC, PC+ABS, ABS, or PC+GF) via a spraying coating process followed by baking at 60-80° C. for 5-10 min to remove the solvent and form a base coat. The photoinitiator decomposed to generate active free radicals via exposure to UV light radiation (UV energy: 400-1600 mJ/cm², light intensity: 80-250 mw/cm²) and initiated a polymerization between the monomer and the resin, forming a film of three-dimensional crosslinked network to obtain the basecoat. The second coating compositions were diluted with a diluent formulated by mixing ethyl acetate, isopropanol, and ethylene glycol monobutyl ether in an appropriate ratio, such that the coating compositions after dilution have a viscosity of 10-15 s. Then, the diluted coating compositions were each coated onto the base coats via a spraying coating process followed by baking at 45-60° C. for 5-10 min to remove the solvent. The photoinitiator decomposed to generate active free radicals via exposure to UV light radiation (UV energy: 400-1600 mJ/cm², light intensity: 80-250 mw/cm²) and initiated a polymerization between the monomer and the resin, forming a film of three-dimensional crosslinked network. Dual-coat Examples 7-9 was thus prepared.

Then, the substrates coated with the dual-coat systems were tested for the following properties. Results were shown in Table 3.

1. Adhesion Testing Between Coating Film and Substrate

The sample surface was cut by 6×6 lines with a NT knife (1 mm² gird (lattice), total number of 25; the marking penetrating all the way to the substrate) and the testing surface remained as even as possible (keeping the blade sharp). If the sample was too small to have enough cross-cutting space, a 45° cross-cut grid would be taken. Nichiban tape (No. 405), Scotch tape (No. 610), or other tapes of the same type (18 mm broad, tape viscosity should be greater than or equal to 5.3 N/18 mm breadth) was applied over the sample surface and compacted with a rubber to allow the tape sufficiently in contact with the sample surface. The sample standed for 3 min. Tape was removed by pulling it off rapidly back over itself in an angle of 90°. The testing surface was visually examined and assessed with reference to ISO standard.

ISO Standard Rating

0 scale: 5B

Edges of incisions are completely smooth, and no peeling occurs at the edges of lattices.

1 scale: 4B

There is a small piece of peeling at the intersections of incisions, and actual failure is less than or equal to 5%.

2 scale: 3B

There is peeling at the edges or intersections of incisions, with a peeling area from 5% to 15%.

3 scale: 2B

There is partial peeling or a large piece of peeling along the edges of incisions, or part of lattices is wholly peeled off, with a peeling area in a range of 15%-35%.

4 scale: 1B

There is much peeling at the edges of incisions, or part or all of some lattices are peeled off, with a peeling area in a range of 35%-65%.

5 scale: 0B

The painting peels off significantly at the edges or intersections of incisions, with a peeling area greater than 65%.

Typically, when the coating system is used for the shell of a mobile phone, the testing result is required at or above 4B.

2. Hardness Testing of Coating Films

A commercial pencil hardness tester was used for measurement under the following conditions: Mitsubishi pencil; load: 9.8N; movement distance: 1 cm, 5 times. Requirements: the coat was not peeled off, cracked and scratched (except pencil indentation caused by pressure) after the surface pencil scratches were erased with an eraser. >=F is required.

3. Solvent Resistance

Testing conditions: methyl ethyl ketone (MEK), load: 50 g, rubbing back and forth for 50 times, rating ≥4. The testing was evaluated as passing if the basecoat was not exposed after testing.

4. RCA Abrasion Testing

A commercial RCA tester was used under the following conditions: a tape model 1116-P-40, load: 175 g, more than 70 times. The testing was evaluated as passing if the basecoat was not exposed after testing.

5. Wet-Wet Cycle Testing

The testing sample was subjected to the following cycle: transiting from 21° C., 60% RH to −40° C. in three hours, and keeping under such conditions for 2 hr; then transiting from −40° C. to 85° C., 50% RH in 6 hours, and keeping under such conditions for 2 hr; transiting to 21° C., 60%RH, one cycle ending. 5 cycles was performed in total.

After testing, the sample surface was examined for presence of obvious color difference. The sample surface was inspected for the presence of blistering, cracking, or deformation. Thereafter, one 405 tape was applied over the coated surface (compacted by finger) and was removed by pulling it off rapidly back over itself in an angle of 90° relative to the coat surface. The coated surface was examined for presence of exfoliation when peeling the tape.

6. Color Stability Testing

Mono cycle: UV radiation for 4 hrs (UV-A, 340 nm, 0.63 W/m²/nm, 60° C.), plus humid storage for 4 hr (50° C.), total 12 cycles (4 days). Half of the sample surface was covered with an aluminum foil (for comparing to the surface after being tested).

After UV radiation, changes in color, gloss, and surface roughness of the sample surface were examined. Change in color was shown by a ΔE value tested by an X-rite colorimeter (dark: ΔE≤0.7; light: ΔE≤1). Before performing the UV testing, the testing plate to be tested was first measured for chromatic aberration by the colorimeter, to obtain L1, a1, and b1 values. After UV radiation, the testing plate was again measured for chromatic aberration by the colorimeter, to obtain L2, a2, and b2 values. The AF value was calculated according to the following equation:

ΔE=\sqrt{(L2−L1)²+(a2−a1)²+(b2−b1)²}

The sample surface was inspected for the presence of blistering or cracking. Thereafter, one 405 tape was applied over the coated surface (compacted by finger) and was removed by pulling it off rapidly back over itself in an angle of 90° relative to the coat surface. The coated surface was examined for presence of exfoliation when peeling the tape.

7. Cosmetics Testing

10 g of each of the following cosmetics items was put in a measuring glass and mixed homogeneously (one cosmetics was used only once and using every other day was prohibited): Dabao Beauty Day Cream/Nivea man hydrating, Dabao refreshing and moisturizing sunscreen/Vaseline intensive care hand & nail, Dabao SOD protein cream/Johnson baby lotion, Johnson baby oil, Coppertone sport sunscreen SPF30, and Coppertone ultraguard sunscreen SPF50. The resulting mixture was coated evenly onto the sample surface with a toothbrush. The sample coated with cosmetics was put in an environment testing furnace, and was tested at a temperature of 70° C. and a humidity of 85% for 48 hrs and 72 hrs. Further, the sample coated with the above cosmetics was placed at normal temperature for 4 hrs.

After testing, changes in color, gloss, and surface roughness of the sample surface were examined. The sample surface was inspected for the presence of blistering or cracking. Thereafter, one 405 tape was applied over the coated surface (compacted by finger) and was removed by pulling it off rapidly back over itself in an angle of 90° relative to the coat surface. The coated surface was examined for presence of exfoliation when peeling the tape.

TABLE 3
Testing results for each performance

| | Example 7 | Example 8 | Example 9 |
|---|---|---|---|
| Adhesion testing | Pass, | Pass, | Pass, |
| between coating | peeling area < 5% | peeling area < 5% | peeling area < 5% |
| film and substrate | | | |
| Hardness testing | Pass, no coating | Pass, no coating | Pass, no coating |
| of coating films | peeling off, | peeling off, | peeling off, |
| | cracking, scratching | cracking, scratching | cracking, scratching |
| Solvent resistance | Pass | Pass | Pass |
| RCA abrasion | Pass, RCA > 70 | Pass, RCA > 70 | Pass, RCA > 70 |
| testing | times | times | times |
| Temperature and | Pass, no change, no | Pass, no change, no | Pass, no change, no |
| wet testing | coating peeling off | coating peeling off | coating peeling off |
| Color stability | Pass, no change, | Pass, no change, | Pass, no change, |
| testing | ΔE = 0.45, no | ΔE = 0.45, no | ΔE = 0.45, no |
| | coating peeling off | coating peeling off | coating peeling off |
| Chemical | Pass, no change, no | Pass, no change, no | Pass, no change, no |
| resistance | coating peeling off | coating peeling off | coating peeling off |
| testing | | | |

Although particular aspects of this invention have been explained and described above, it will be evident to those skilled in the art that numerous variations and modifications to the present invention may be made without departing from the scope and spirit of the present invention. Therefore, the appended claims are intended to encompass these variations and modifications falling within the present invention.

1. A multi-layer coating system, comprising a first UV curable coating composition and a second UV curable coating composition, wherein the first UV curable composition comprises a low hydroxyl polyurethane resin and a polyurethane acrylate oligomer, and the second UV curable composition comprises a polyurethane acrylate oligomer and an active monomer.

2. The multi-layer coating system according to claim 1, wherein the low hydroxyl polyurethane resin in the first UV curable coating composition has a hydroxyl value from 20 to 30 KOH/g and a weight average molecular weight from 5000 to 20000.

3. The multi-layer coating system according to claim 1, wherein the polyurethane acrylate oligomer in the first UV curable coating composition comprises a two-functionality polyurethane acrylate oligomer.

4. The multi-layer coating system according to claim 3, wherein the two-functionality polyurethane acrylate oligomer has a weight average molecular weight from 20000 to 50000.

5. The multi-layer coating system according to claim 1, wherein the polyurethane acrylate oligomer in the second UV curable coating composition has a weight average molecular weight from 1000 to 20000.

6. The multi-layer coating system according to claim 5, wherein the polyurethane acrylate oligomer comprises a polyurethane acrylate oligomer (a) and a polyurethane acrylate oligomer (b).

7. The multi-layer coating system according to claim 6, wherein the polyurethane acrylate oligomer (a) comprises two-functionality polyurethane acrylate.

8. The multi-layer coating system according to claim 6, wherein the polyurethane acrylate oligomer (b) comprises aliphatic polyurethane acrylate having a functionality from 6 to 9.

9. The multi-layer coating system according to any one of the preceding claims, wherein the active monomer is a two-functionality active monomer.

10. A method of forming a multi-layer coating system on a substrate, comprising:
(1) applying a first UV curable coating composition to at least a portion of the substrate, to form a base coat; and
(2) applying a second UV curable coating composition to at least a portion of the base coat, to form a clear coat,
wherein the first UV curable composition comprises a low hydroxyl polyurethane resin and a polyurethane acrylate oligomer, and the second UV curable composition comprises a polyurethane acrylate oligomer and an active monomer.

11. A coated substrate, comprising:
(i) a substrate, and
(ii) a multi-layer coating system deposited on at least a portion of the substrate,
Wherein the multi-layer coating system comprises a first UV curable coating composition and a second UV curable composition, wherein the first UV curable composition comprises a low hydroxyl polyurethane resin and a polyurethane acrylate oligomer, and the second UV curable composition comprises a polyurethane acrylate oligomer and an active monomer.

12. The coated substrate according to claim 11, wherein the substrate comprises a plastic substrate formed from the group consisting of polypropylene, acrylonitrile-butadiene-styrene copolymer, glass fiber, and any combination thereof.

13. The coated substrate according to claim 11, wherein the substrate is a substrate useful for a mobile phone, a personal digital assistant, a smart-phone, and a personal computer.
